(19) United States
(12) Patent Application Publication
(10) Pub. No.: US 2021/0094615 A1
(43) Pub. Date: Apr. 1, 2021

(54) USER-RESOLVED ACTIVATION SEQUENCE IN ASSISTED HITCHING OPERATION

(71) Applicant: Ford Global Technologies, LLC, Dearborn, MI (US)

(72) Inventors: Luke Niewiadomski, Dearborn, MI (US); Arnav Sharma, Canton, MI (US); Roger Trombley, Ann Arbor, MI (US)

(73) Assignee: Ford Global Technologies, LLC, Dearborn, MI (US)

(21) Appl. No.: 16/587,550

(22) Filed: Sep. 30, 2019

(51) Int. Cl. B62D 13/00; B62D 15/02; B60R 1/00

(52) U.S. Cl. CPC B62D 13/00; B60R 2300/808; B60R 1/00; B62D 15/029

(57) ABSTRACT

A system for assisting in aligning a vehicle for hitching with a trailer includes a steering system including a set of vehicle steered wheels and a controller. The controller checks the system for a plurality of pre-maneuver conditions and communicates to a driver the need to correct at least one of the pre-maneuver conditions. When all pre-maneuver conditions are met, the controller executes an automated hitching maneuver that includes controlling the steered wheels of the steering system in backing the vehicle toward the trailer.

### FIELD OF THE INVENTION

The present invention generally relates to a vehicle hitch assistance system. In particular, the system identifies and coaches a user to rectify a number of system preconditions.

### BACKGROUND OF THE INVENTION

Hitching a trailer to a vehicle can be a difficult and time-consuming experience. In particular, aligning a vehicle hitch ball with the desired trailer hitch can, depending on the initial location of the trailer relative to the vehicle, require repeated forward and reverse driving coordinated with multiple steering maneuvers to appropriately position the vehicle. Further, through a significant portion of the driving needed for appropriate hitch ball alignment, the trailer hitch cannot be seen, and the hitch ball can, under ordinary circumstance, never actually be seen by the driver. This lack of sight lines requires inference of the positioning of the hitch ball and hitch based on experience with a particular vehicle and trailer, and can still require multiple instances of stopping and stepping out of the vehicle to confirm alignment or to note an appropriate correction for a subsequent set of maneuvers. Even further, the closeness of the hitch ball to the rear bumper of the vehicle means that any overshoot can cause the vehicle to come into contact with the trailer. Accordingly, further advancements may be desired.

### SUMMARY OF THE INVENTION

According to one aspect of the present disclosure, a system for assisting in aligning a vehicle for hitching with a trailer includes a steering system including a set of vehicle steered wheels and a controller. The controller checks the system for a plurality of pre-maneuver conditions and communicates to a driver the need to correct at least one of the pre-maneuver conditions. When all pre-maneuver conditions are met, the controller executes an automated hitching maneuver that includes controlling the steered wheels of the steering system in backing the vehicle toward the trailer.

Embodiments of the first aspect of the invention can include any one or a combination of the following features:
the system further includes an imaging system outputting image data, and, prior to checking the system for the plurality of pre-maneuver conditions, the controller identifies a coupler of the trailer within the image data and executing the automated hitching maneuver is carried out to move the vehicle into an aligned position, wherein a hitch ball mounted on the vehicle is aligned with a coupler of the trailer, and includes tracking a position of the coupler relative to the hitch ball in the image data;
the controller continues to track a location of the coupler within the image data when communicating the driver the need to correct the at least one of the pre-maneuver conditions;
when checking the system for the plurality of pre-maneuver conditions, the controller identifies the at least one of the pre-maneuver conditions to be corrected, starts a timer upon communicating the need to correct the at least one pre-maneuver condition to the driver, and after a predetermined timeout period, cancels the automated hitching maneuver;
when checking the system for the plurality of pre-maneuver conditions, the controller identifies at least two pre-maneuver conditions to be corrected, communicates the need to correct a predetermined first one of one of the at least two pre-maneuver conditions, and only communicates a need to correct a predetermined second one of the at least two pre-maneuver conditions after determining that the first one has been corrected;
when communicating to the driver the need to correct at least one of the pre-maneuver conditions, all of the at least one of the pre-maneuver conditions are simultaneously communicated in a predetermined order;
the plurality of pre-maneuver conditions includes at least one of the group consisting of: a vehicle tailgate being closed, a vehicle hitch being installed, obstacles between the vehicle and the trailer being moved, a plurality of vehicle doors being closed, the vehicle being stationary, and a vehicle engine being in a running state;
the controller also monitors for a plurality of maneuver abort conditions simultaneously with checking the system for the plurality of pre-maneuver conditions and executing the automated hitching maneuver and either disables or ends the automated hitching maneuver upon detecting one of the plurality of maneuver abort conditions; and
the system further includes a powertrain control system and a brake system, and executing the automated hitching maneuver further includes controlling the powertrain system and the brake system to back the vehicle toward the trailer and to stop the vehicle when a hitch of the vehicle is vertically aligned with a coupler of the trailer.

According to another aspect of the present disclosure, a vehicle includes a steering system including a set of steered wheels and a system for assisting in aligning the vehicle for hitching with a trailer. The system includes a controller checking the vehicle for a plurality of pre-maneuver conditions, communicating to a driver of the vehicle the need to correct at least one of the pre-maneuver conditions, and, when all pre-maneuver conditions are met, executing an automated hitching maneuver including controlling the steered wheels of the steering system in backing the vehicle toward the trailer.

According to another aspect of the present disclosure, a method for aligning a vehicle for hitching with a trailer includes checking the vehicle for a plurality of pre-maneuver conditions and communicating to a driver of the vehicle the need to correct at least one of the pre-maneuver conditions. When all pre-maneuver conditions are met, the method includes executing an automated hitching maneuver including controlling a set of steered wheels of a steering system of the vehicle in backing the vehicle toward the trailer.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective view of a vehicle in an unhitched position relative to a trailer;

FIG. 2 is a diagram of a system according to an aspect of the disclosure for assisting in aligning the vehicle with a trailer in a position for hitching the trailer to the vehicle;

FIG. 3 is an overhead schematic view of a vehicle during a step of the alignment sequence with the trailer;

FIG. 4 is an overhead schematic view of the vehicle during a subsequent step of the alignment sequence with the trailer;

FIG. 5 is an overhead schematic view of the vehicle during a subsequent step of the alignment sequence with the trailer;

FIG. 6 is an overhead schematic view of the vehicle during a subsequent step of the alignment sequence with the trailer and showing the position of a hitch ball of the vehicle at an end of a derived alignment path;

FIG. 7 is a flowchart depicting logic implemented by system according to a method for identifying and coaching a user to rectify a number of system use preconditions;

FIG. 8 is an example of a message displayed on a vehicle HMI to a driver with an instruction to rectify a use precondition;

FIGS. 9A and 9B are examples of messages displayed on a vehicle HMI to a driver with an indication of system operation termination;

FIG. 10 is a flowchart depicting alternative logic implemented by variation of the system according to an alternative method for identifying and coaching a user to rectify a number of system use preconditions; and

FIG. 11 is an example of a message displayed on a vehicle HMI to a driver with a list of instructions to rectify a plurality of use preconditions.

### DETAILED DESCRIPTION OF THE PREFERRED EMBODIMENTS

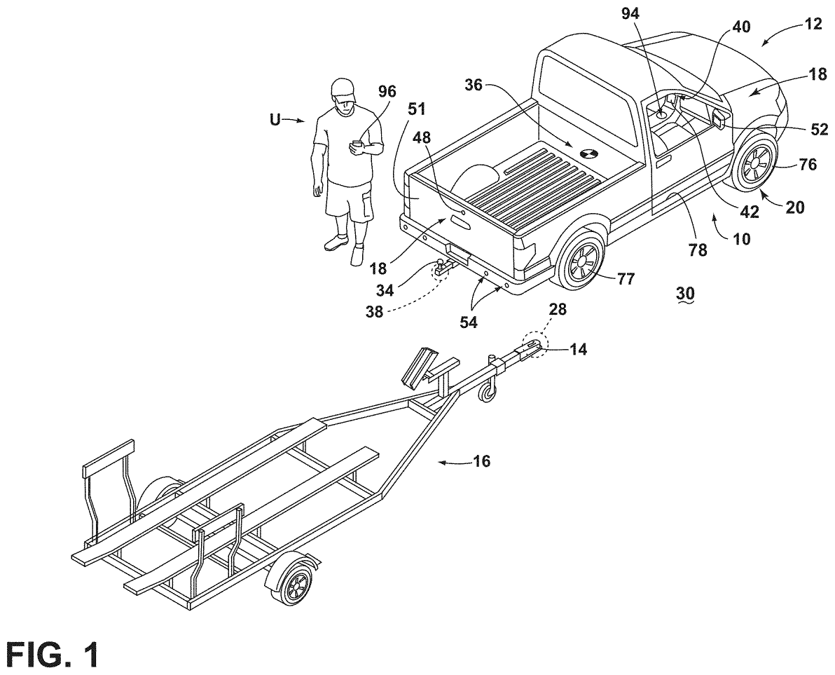

For purposes of description herein, the terms “upper,” “lower,” “right,” “left,” “rear,” “front,” “vertical,” “horizontal,” “interior,” “exterior,” and derivatives thereof shall relate to the device as oriented in FIG. 1. However, it is to be understood that the device may assume various alternative orientations, except where expressly specified to the contrary. It is also to be understood that the specific devices and processes illustrated in the attached drawing, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise. Additionally, unless otherwise specified, it is to be understood that discussion of a particular feature of component extending in or along a given direction or the like does not mean that the feature or component follows a straight line or axis in such a direction or that it only extends in such direction or on such a plane without other directional components or deviations, unless otherwise specified.

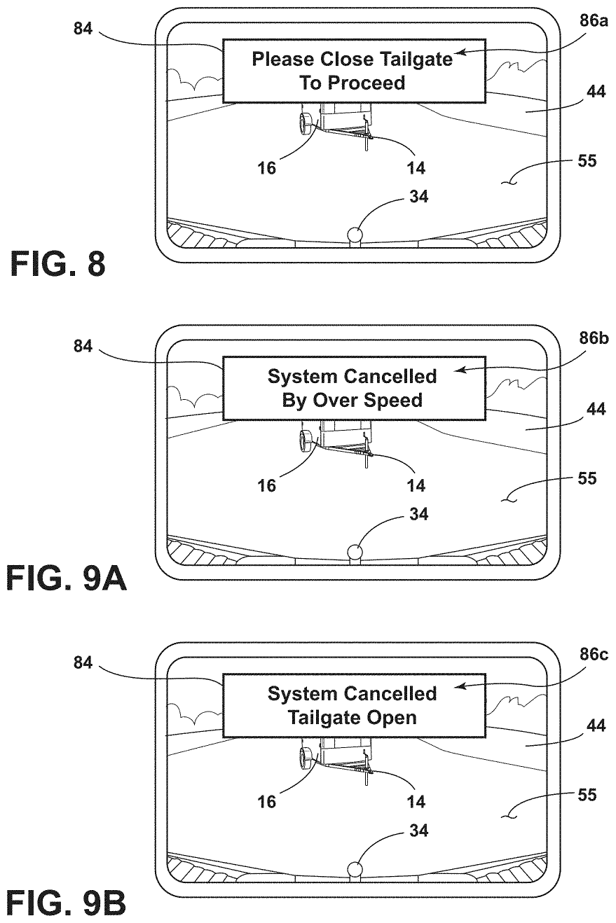

Referring generally to FIGS. 1-9B, reference numeral 10 designates a hitch assistance system (also referred to as a “hitch assist” system or a “hitching assistance” system) for a vehicle 12. In particular system 10 include a steering system 20 including a set of vehicle steered wheels 76 and a controller 26. The controller 26 checks the system 10 for a plurality of pre-maneuver conditions and communicates to a driver the need to correct at least one of the pre-maneuver conditions. When all pre-maneuver conditions are met, the controller 26 executes an automated hitching maneuver that includes controlling the steered wheels 76 of the steering system 20 in backing the vehicle 12 toward the trailer 16.

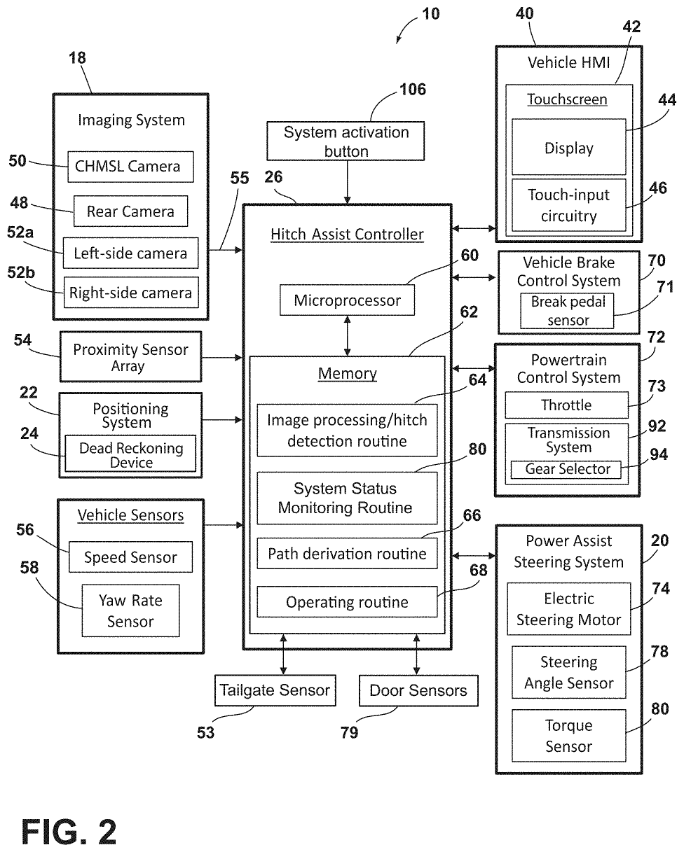

With respect to the general operation of the hitch assist system 10, as illustrated in the system diagram of FIG. 2, system 10 includes various sensors and devices that obtain or otherwise provide vehicle status-related information. This information includes positioning information from a positioning system 22, which may include a dead reckoning device 24 or, in addition or as an alternative, a global positioning system (GPS), to determine a coordinate location of the vehicle 12 based on the one or more locations of the devices within the positioning system 22. In particular, the dead reckoning device 24 can establish and track the coordinate location of the vehicle 12 within a localized coordinate system 82 based at least on vehicle speed and steering angle δ. Other vehicle information received by hitch assist system 10 may include a speed of the vehicle 12 from a speed sensor 56 and a yaw rate of the vehicle 12 from a yaw rate sensor 58. It is contemplated that in additional embodiments, a proximity sensor 54 or an array thereof, and other vehicle sensors and devices may provide sensor signals or other information, such as sequential images of a trailer 16, including the detected coupler 14, that the controller 26 of the hitch assist system 10 may process with various routines to determine the height H and position of coupler 14.

As further shown in FIG. 2, one embodiment of the hitch assist system 10 is in communication with the steering system 20 of vehicle 12, which may be a power assist steering system 20 including an electric steering motor 74 to operate the steered wheels 76 (FIG. 1) of the vehicle 12 for moving the vehicle 12 in such a manner that the vehicle yaw changes with the vehicle velocity and the steering angle δ. In the illustrated embodiment, the power assist steering system 20 is an electric power-assisted steering (“EPAS”) system including electric steering motor 74 for turning the steered wheels 76 to a steering angle δ based on a steering command, whereby the steering angle δ may be sensed by a steering angle sensor 78 of the power assist steering system 20. The steering command 69 may be provided by the hitch assist system 10 for autonomously steering during a trailer hitch alignment maneuver and may alternatively be provided manually via a rotational position (e.g., steering wheel angle) of a steering wheel of vehicle 12. However, in the illustrated embodiment, the steering wheel of the vehicle 12 is mechanically coupled with the steered wheels 76 of the vehicle 12, such that the steering wheel moves in concert with steered wheels 76, preventing manual intervention with the steering wheel during autonomous steering. More specifically, a torque sensor 80 is provided on the power assist steering system 20 that senses torque on the steering wheel that is not expected from autonomous control of the steering wheel and therefore indicative of manual intervention, whereby the hitch assist system 10 may alert the driver to discontinue manual intervention with the steering wheel and/or discontinue autonomous steering. In alternative embodiments, some vehicles have a power assist steering system 20 that allows a steering wheel to be partially decoupled from movement of the steered wheels 76 of such a vehicle.

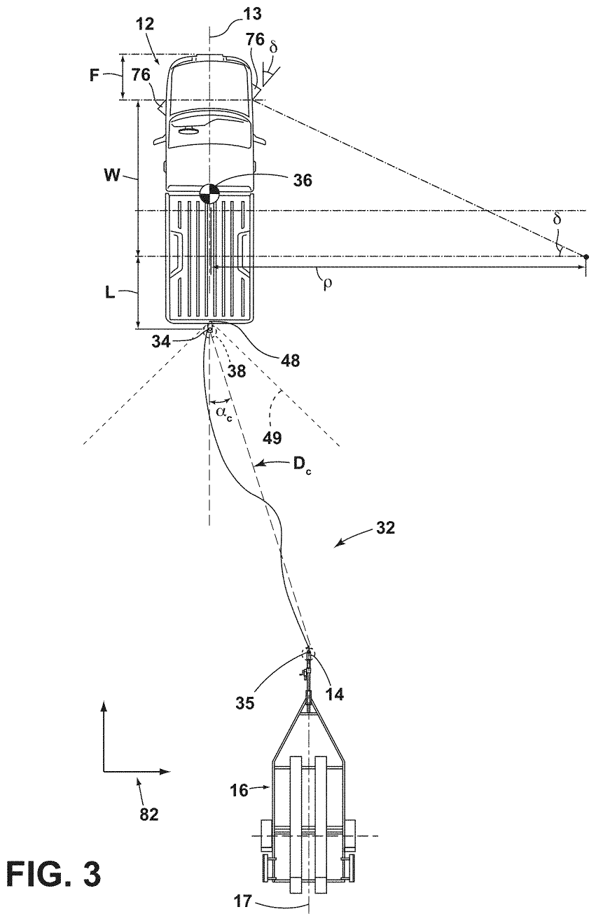

With continued reference to FIG. 2, the power assist steering system 20 provides the controller 26 of the hitch assist system 10 with information relating to a rotational position of steered wheels 76 of the vehicle 12, including a steering angle δ. The controller 26 in the illustrated embodiment processes the current steering angle, in addition to other vehicle 12 conditions to guide the vehicle 12 along the desired path 32 (FIG. 3). It is conceivable that the hitch assist system 10, in additional embodiments, may be an integrated component of the power assist steering system 20. For example, the power assist steering system 20 may include a hitch assist algorithm for generating vehicle steering information and commands as a function of all or a portion of information received from the imaging system 18, the power assist steering system 20, a vehicle brake control system 70, a powertrain control system 72, and other vehicle 12 sensors and devices, as well as a human-machine interface 40, as discussed further below.

As also illustrated in FIG. 2, the vehicle brake control system 70 may also communicate with the controller 26 to provide the hitch assist system 10 with braking information, such as vehicle wheel speed, and to receive braking commands from the controller 26. For instance, vehicle speed information can be determined from individual wheel speeds as monitored by the brake control system 70. Vehicle speed may also be determined from the powertrain control system 72, the speed sensor 56, and the positioning system 22, among other conceivable means. In some embodiments, individual wheel speeds can also be used to determine a vehicle yaw rate \dot{γ}, which can be provided to the hitch assist system 10 in the alternative or in addition to the vehicle yaw rate sensor 58. The hitch assist system 10 can, further, provide vehicle braking information to the brake control system 70 for allowing the hitch assist system 10 to control braking of the vehicle 12 during backing of the trailer 16. For example, the hitch assist system 10, in some embodiments, may regulate speed of the vehicle 12 during alignment of the vehicle 12 with the coupler 14 of trailer 16, which can reduce the potential for a collision with trailer 16, and can bring vehicle 12 to a complete stop at a determined endpoint 35 of path 32. It is disclosed herein that the hitch assist system 10 can additionally or alternatively issue an alert signal corresponding to a notification of an actual, impending, and/or anticipated collision with a portion of trailer 16. The powertrain control system 72, as shown in the embodiment illustrated in FIG. 2, may also interact with the hitch assist system 10 for regulating speed and acceleration of the vehicle 12 during partial or autonomous alignment with trailer 16. As mentioned above, regulation of the speed of the vehicle 12 may be advantageous to prevent collision with trailer 16.

Additionally, the hitch assist system 10 may communicate with human-machine interface (“HMI”) 40 for the vehicle 12. The HMI 40 may include a vehicle display 44, such as a center-stack mounted navigation or entertainment display (FIG. 1). HMI 40 further includes an input device, which can be implemented by configuring display 44 as a portion of a touchscreen 42 with circuitry 46 to receive an input corresponding with a location over display 44. Other forms of input, including one or more joysticks, digital input pads, or the like can be used in place or in addition to touchscreen 42. Further, the hitch assist system 10 may communicate via wireless communication with another embodiment of the HMI 40, such as with one or more handheld or portable devices 96 (FIG. 1), including one or more smartphones. The portable device 96 may also include the display 44 for displaying one or more images and other information to a user. For instance, the portable device 96 may display one or more images of the trailer 16 on the display 44 and may be further able to receive remote user inputs via touchscreen circuitry 46. In addition, the portable device 96 may provide feedback information, such as visual, audible, and tactile alerts.

Still referring to the embodiment shown in FIG. 2, the controller 26 is configured with a microprocessor 60 to process logic and routines stored in memory 62 that receive information from the above-described sensors and vehicle systems, including the imaging system 18, the power assist steering system 20, the vehicle brake control system 70, the powertrain control system 72, and other vehicle sensors and devices. The controller 26 may generate vehicle steering information and commands as a function of all or a portion of the information received. Thereafter, the vehicle steering information and commands may be provided to the power assist steering system 20 for affecting steering of the vehicle 12 to achieve a commanded path 32 (FIG. 3) of travel for alignment with the coupler 14 of trailer 16. The controller 26 may include the microprocessor 60 and/or other analog and/or digital circuitry for processing one or more routines. Also, the controller 26 may include the memory 62 for storing one or more routines, including an image processing routine 64 and/or hitch detection routine, a path derivation routine 66, and an operating routine 68. It should be appreciated that the controller 26 may be a stand-alone dedicated controller or may be a shared controller integrated with other control functions, such as integrated with a vehicle sensor system, the power assist steering system 20, and other conceivable onboard or off-board vehicle control systems. It should further be appreciated that the image processing routine 64 may be carried out by a dedicated processor, for example, within a stand-alone imaging system for vehicle 12 that can output the results of its image processing to other components and systems of vehicle 12, including microprocessor 60. Further, any system, computer, processor, or the like that completes image processing functionality, such as that described herein, may be referred to herein as an “image processor” regardless of other functionality it may also implement (including simultaneously with executing image processing routine 64).

System 10 can also incorporate an imaging system 18 that includes one or more exterior cameras, which in the illustrated examples include rear camera 48, center high-mount stop light (CHMSL) camera 50, and side-view cameras 52a and 52b, although other arrangements including additional or alternative cameras are possible. In one example, imaging system 18 can include rear camera 48 alone or can be configured such that system 10 utilizes only rear camera 48 in a vehicle with multiple exterior cameras. In another example, the various cameras 48, 50, 52a, 52b included in imaging system 18 can be positioned to generally overlap in their respective fields of view, which may correspond with rear camera 48, center high-mount stop light (CHMSL) camera 50, and side-view cameras 52a and 52b, respectively. In this manner, image data 55 from two or more of the cameras can be combined in image processing routine 64, or in another dedicated image processor within imaging system 18, into a single image. In an extension of such an example, the image data 55 can be used to derive stereoscopic image data that can be used to reconstruct a three-dimensional scene of the area or areas within overlapped areas of the various fields of view 49, 51, 53a, 53b, including any objects (obstacles or coupler 14, for example) therein. In an embodiment, the use of two images including the same object can be used to determine a location of the object relative to the two image sources, given a known spatial relationship between the image sources. In this respect, the image processing routine 64 can use known programming and/or functionality to identify an object within image data 55 from the various cameras 48, 50, 52a, and 52b within imaging system 18. In either example, the image processing routine 64 can include information related to the positioning of any cameras 48, 50, 52a, and 52b present on vehicle 12 or utilized by system 10, including relative to the center 36 (FIG. 1) of vehicle 12, for example such that the positions of cameras 48, 50, 52a, and 52b relative to center 36 and/or to each other can be used for object positioning calculations and to result in object position data relative to the center 36 of vehicle 12, for example, or other features of vehicle 12, such as hitch ball 34 (FIG. 1), with known positions relative to center 36. In one aspect, the various systems and vehicle features discussed herein, including imaging system 18, positioning system 22, brake control system 70, powertrain control system 72, power assist steering system 20, proximity sensor array 54, positioning system 22, and the vehicle sensors discussed herein my generally used for purposes of vehicle control, such as under control of the user, including potentially with assistance of an on-board computer or other processor communicating with the systems and features. In this manner, the systems and features can be referred to collectively as a vehicle control system that may be utilized by controller 26 for the automatic vehicle control functionality discussed herein.

The image processing routine 64 can be specifically programmed or otherwise configured to locate coupler 14 within image data 55. In an example, the image processing routine 64 can first attempt to identify any trailers 16 within the image data 55, which can be done based on stored or otherwise known visual characteristics of trailer 16, of an number of different types, sizes or configurations of trailers compatible with system 10, or trailers in general. Controller 26 can seek confirmation from the user that the identification of the trailer 16 is accurate and is the correct trailer for which to complete an assisted hitching operation, as described further below. After the trailer 16 is identified, controller 26 may then identify the coupler 14 of that trailer 16 within the image data 55 based, similarly, on stored or otherwise known visual characteristics of coupler 14 or couplers in general. In another embodiment, a marker in the form of a sticker or the like may be affixed with trailer 16 in a specified position relative to coupler 14 in a manner similar to that which is described in commonly-assigned U.S. Pat. No. 9,102,271, the entire disclosure of which is incorporated by reference herein. In such an embodiment, image processing routine 64 may be programmed with identifying characteristics of the marker for location in image data 55, as well as the positioning of coupler 14 relative to such a marker so that the position 28 of coupler 14 can be determined based on the marker location. Additionally or alternatively, controller 26 may seek confirmation of the determined coupler 14, via a prompt on touchscreen 42. If the coupler 14 determination is not confirmed, further image processing may be provided, or user-adjustment of the position 28 of coupler 14 may be facilitated, either using touchscreen 42 or another input to allow the user to move the depicted position 28 of coupler 14 on touchscreen 42, which controller 26 uses to adjust the determination of position 28 of coupler 14 with respect to vehicle 12 based on the above-described use of image data 55.

In various examples, controller 26 may initially rely on the identification of trailer 16 for the initial stages of an automated hitching operation, with the path 32 being derived to move the hitch ball 34 toward a centrally-aligned position with respect to trailer 16 with the path 32 being refined once the coupler 14 is identified. Such an operational scheme can be implemented when it is determined that trailer 16 is at a far enough distance from vehicle 12 to begin backing without knowing the precise endpoint 35 of path 32 and can be useful when trailer 16 is at a distance where the resolution of the image data 55 makes it possible to accurately identify trailer 16, but at which the coupler 14 cannot be precisely identified. In this manner, initial rearward movement of vehicle 12 can allow for calibration of various system 10 inputs or measurements that can improve the accuracy of distance measurements, for example, that can help make coupler 14 identification more accurate. Similarly, movement of vehicle 12 resulting in a change to the particular image within the data 55 that can improve the resolution or move the coupler 14 relative to the remaining portions of trailer 16 such that it can be more easily identified.

As shown in FIG. 3, the image processing routine 64 and operating routine 68 may be used in conjunction with each other to determine the path 32 along which hitch assist system 10 can guide vehicle 12 to align hitch ball 34 and coupler 14 of trailer 16. Upon initiation of hitch assist system 10, such as by user input on touchscreen 42, for example, image processing routine 64 can identify coupler 14 within the image data 55 and at least attempt to estimate the position 28 of coupler 14 relative to hitch ball 34 using the image data 55 in accordance with one of the examples discussed above to determine a distance D_{c} to coupler 14 and an angle α_{c} of offset between a line connecting hitch ball 34 and coupler 14 and the longitudinal axis 13 of vehicle 12. Image processing routine 64 can also be configured to identify the trailer 16 overall and can use the image data of trailer 16, alone or in combination with the image data 55 of coupler 14, to determine the orientation or heading 33 of trailer 16. In this manner the path 32 can further be derived to align vehicle 12 with respect to trailer 16 with the longitudinal axis 13 of vehicle 12 within a predetermined angular range of the heading 33 of trailer 16. Notably, such alignment may not require that the longitudinal axis 13 of vehicle 12 is parallel or collinear with the heading 33 of trailer 16, but may simply be within a range that generally allows connection of hitch ball 34 with coupler 14 without collision between vehicle 12 and trailer 16 and may, further allow immediate controlled backing of trailer 16 using vehicle 12. In this manner, the angular range may be such that the alignment of vehicle 12 with trailer 16 at the end of the operating routine 68 is such that the angle between longitudinal axis 13 and heading 33 is less than the jackknife angle between the vehicle 12 and trailer 16 when coupled or a reasonable estimate thereof. In one example, the angular range may be such that longitudinal axis 13 is within about 30° from collinear with heading 33 in either direction.

Continuing with reference to FIG. 3 with additional reference to FIG. 2, controller 26, having estimated the positioning D_{c}, α_{c} of coupler 14, as discussed above, can, in one example, execute path derivation routine 66 to determine vehicle path 32 to align the vehicle hitch ball 34 with coupler 14. In particular, controller 26 can have stored in memory 62 various characteristics of vehicle 12, including the wheelbase W, the distance from the rear axle to the hitch ball 34, which is referred to herein as L, as well as the maximum angle to which the steered wheels 76 can be turned δₘₐₓ. As shown, the wheelbase W and the current steering angle δ can be used to determine a corresponding turning radius ρ for vehicle 12 according to the equation:

$$ρ = \frac{W}{tan δ} , \qquad ( 1 )$$

in which the wheelbase W is fixed and the steering angle δ can be controlled by controller 26 by communication with steering system 20, as discussed above. In this manner, when the maximum steering angle δₘₐₓ is known, the smallest possible value for the turning radius ρₘᵢₙ is determined as:

$${ρ}_{min} = \frac{W}{tan {δ}_{max}} . \qquad ( 2 )$$

Path derivation routine 66 can be programmed to derive vehicle path 32 to align a known location of the vehicle hitch ball 34 with the estimated position 28 of coupler 14 that takes into account the determined minimum turning radius ρₘᵢₙ to allow path 32 to use the minimum amount of space and maneuvers. In this manner, path derivation routine 66 can use the position of vehicle 12, which can be based on the center 36 of vehicle 12, a location along the rear axle, the location of the dead reckoning device 24, or another known location on the coordinate system 82, to determine both a lateral distance to the coupler 14 and a forward or rearward distance to coupler 14 and derive a path 32 that achieves the needed lateral and forward-backward movement of vehicle 12 within the limitations of steering system 20. The derivation of path 32 further takes into account the positioning of hitch ball 34, based on length L, relative to the tracked location of vehicle 12 (which may correspond with the center 36 of mass of vehicle 12, the location of a GPS receiver, or another specified, known area) to determine the needed positioning of vehicle 12 to align hitch ball 34 with coupler 14. It is noted that hitch assist system 10 can compensate for horizontal movement Δx of coupler 14 in a driving direction by determining the movement of coupler 14 in the vertical direction Δy that will be needed to receive hitch ball 34 within coupler 14. Such functionality is discussed further in co-pending, commonly-assigned U.S. pat. app. Ser. Nos. 14/736,391 and 16/038,462, the entire disclosures of which are hereby incorporated by reference herein.

As discussed above, once the desired path 32, including endpoint 35, has been determined, controller 26 is then allowed to at least control the steering system 20 of vehicle 12 with the powertrain control system 72 and the brake control system 70 (whether controlled by the driver or by controller 26, as discussed below) controlling the velocity (forward or rearward) of vehicle 12. In this manner, controller 26 can receive data regarding the position of vehicle 12 during movement thereof from positioning system 22 while controlling steering system 20, as needed to maintain vehicle 12 along path 32. In particular, the path 32, having been determined based on the vehicle 12 and the geometry of steering system 20, can adjust the steering angle δ, as dictated by path 32, depending on the position of vehicle 12 therealong. It is additionally noted that in an embodiment, the path 32 may comprise a progression of steering angle δ adjustment that is dependent on the tracked vehicle position.

As illustrated in FIG. 3, vehicle path 32 can be determined to achieve the needed lateral and rearward movement within the smallest area possible and/or with the lowest number of maneuvers. In the illustrated example of FIG. 3, path 32 can include two portions defined by steering of wheels 76 in different directions to collectively traverse the needed lateral movement of vehicle 12, while providing final straight, rearward backing segment to bring hitch ball 34 into the above-described offset alignment with coupler 14. It is noted that variations in the depicted path 32 may be used. It is further noted that the estimates for the positioning D_{c}, α_{c} of coupler 14 may become more accurate as vehicle 12 traverses path 32, including to position vehicle 12 in front of trailer 16 and as vehicle 12 approaches coupler 14. Accordingly, such estimates can be continuously derived and used to update path derivation routine 66, if necessary, in the determination of the adjusted endpoint 35 for path 32, as discussed above. In a similar manner, the path 32, as derived using the position and orientation data acquired from a portable device 96, such a smartphone, can be fine-tuned once the image processing routine 64 can identify coupler 14 in the image data 55, with continued updates for path 32 being similarly derived as the image data 55 becomes increasingly clear during the approach toward trailer 16. It is further noted that, until such a determination can be made, the dead reckoning device 24 can be used to track the location of vehicle 12 in its movement along path 32 toward the initially-derived endpoint 35.

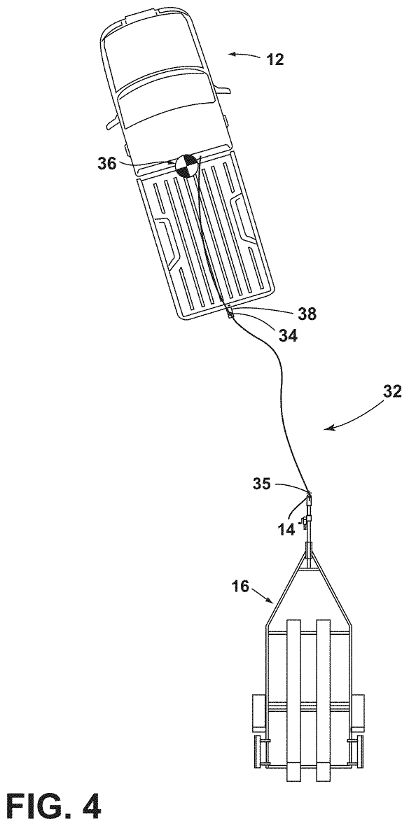

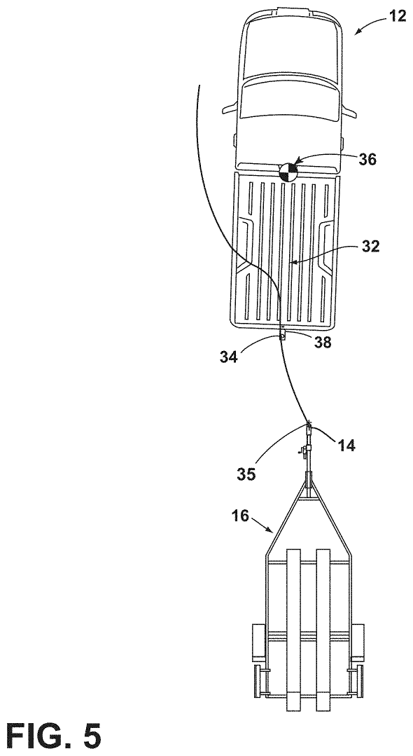

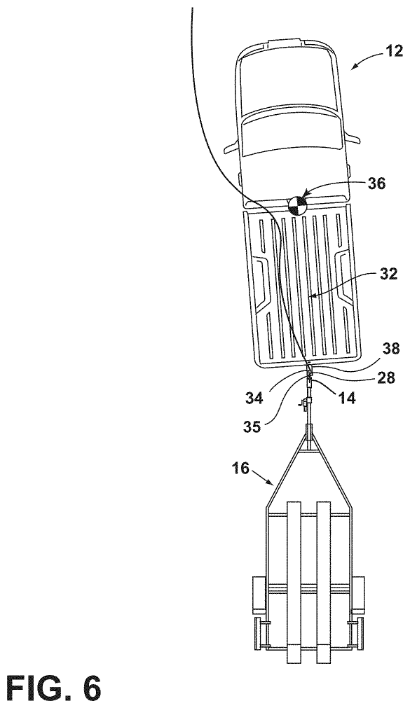

As shown in FIGS. 4-6, once the trailer 16 and coupler 14 have been identified, and system 10 determines the path 32 to align hitch ball 34 with the coupler 14, the controller 26 executing operating routine 68 may continue to control vehicle 12 until hitch ball 34 is in the desired endpoint 35 relative to coupler 14 for coupler 14 to engage with hitch ball 34 when coupler 14 is lowered into horizontal alignment therewith. In the example discussed above, image processing routine 64 continuously monitors the positioning D_{c},α_{c} of coupler 14, constantly or once available, during execution of operating routine 68, including as coupler 14 comes into clearer view of rear camera 48, with continued movement of vehicle 12 along path 32. As discussed above, the position of vehicle 12 can also be monitored by dead reckoning device 24 with the position 28 of coupler 14 being continuously updated and fed into path derivation routine 66 in case path 32 and or endpoint 35 can be refined or should be updated (due to, for example, improved height H_{c}, distance D_{c}, or offset angle α_{c} information due to closer resolution or additional image data 55), including as vehicle 12 moves closer to trailer 16, as shown in FIGS. 4 and 5. Still further, the coupler 14 can be assumed to be static such that the position of vehicle 12 can be tracked by continuing to track the coupler 14 to remove the need for use of the dead reckoning device 24. In a similar manner, a modified variation of operating routine 68 can progress through a predetermined sequence of maneuvers involving steering of vehicle 12 at or below a maximum steering angle δₘₐₓ, while tracking the position D_{c}, α_{c} of coupler 14 to converge the known relative position of hitch ball 34 to the desired position 38d thereof relative to the tracked position 28 of coupler 14, as discussed above and shown in FIG. 6.

During an assisted hitching operation, such as in the example described with respect to FIGS. 4-6, system 10 requires a minimum amount of longitudinal distance between the vehicle 12 and the trailer 16 to control movement of vehicle 12 with a level of precision desired to achieve the desired final position of hitch ball 34 with respect to coupler 14 (i.e., without overshooting the desired final location, such that hitch ball 34 moves past the coupler 14, or otherwise ending operating routine 68 with hitch ball 34 positioned relative to coupler 14 such that manual movement of trailer 16 is required). The required minimum distance can vary but is generally influenced by the requirements of image processing routine 64, as well as the requirements of speed sensor 56, the responsiveness of the throttle 73 and vehicle brake control system 70, as well as the general processing speed of controller 26 of other components of system 10. In one example, image processing routine 64 may require a minimum travel distance for self-calibration, including to accurately identify coupler 14 and to assist in tracking of vehicle 12 movement. In general, because of the minimum travel distance requirement, if vehicle 12 is at a standstill with insufficient longitudinal distance remaining between hitch ball 34 and coupler 14, the system 10 is programmed to either not initiate operating routine 68 or, if already started, abort operating routine 68 to avoid the risk of overshooting the final target position such that hitch ball 34 moves past endpoint 35. In various examples, vehicle 12 may be brought to a standstill for reasons other than operating routine 68 causing the application of the vehicle brakes 70. In particular, vehicle 12 may come to a standstill before reaching the desired final target position due to uneven terrain acting on the vehicle wheels 76 or 77, or by the vehicle brakes 70 being manually applied by the driver. Because such events can cause a vehicle 12 standstill at any point along path 32, the present system 10 provides the ability to detect such a standstill event and to address it appropriately given the capabilities and requirements of system 10. In various examples, system 10 can address an early standstill by aborting, pausing, or automatically rectifying the standstill condition.

As mentioned above, the “longitudinal control” in an assisted hitching maneuver is the portion of vehicle 12 movement along path 32 controlled by the vehicle powertrain control system 72 and the vehicle brake system 70 with the “longitudinal control” being the portion controlled by the power assist steering system 20. It is to be understood that the lateral control requires movement of the vehicle such that the two control schemes operate together to move vehicle 12 along the path 32. In this respect, the longitudinal alignment of the path 32 with the coupler 14 is dictated by the longitudinal control (i.e., by the steering system 20) and the final stopping point of vehicle 12 along path 32 is dictated by the longitudinal control. In this respect, the final stopping point of the vehicle 12 along path 32 determines the alignment in the direction of travel between hitch ball 34 and coupler 14. In this manner, system 10 may be able to move vehicle 12 to the final target position in a precise manner, for example, such that trailer 16 does not have to be manually repositioned by the user, but can simply be lowered onto hitch ball 34. In one implementation of system 10, the accuracy in final longitudinal alignment of hitch ball 34 with coupler 14 can be to within 1 cm of a completely aligned position (center-to-center). Again, the particular implementation of system 10 can be such that controller 26 requires a minimum amount of longitudinal travel distance to perform a sequence of events for the desired hitch ball 34 and coupler 14 alignment. Such a sequence can include increasing the engine speed (using throttle 73 via powertrain control system 72) and reducing the brake pressure (via brake control system 70) until vehicle 12 begins moving. Controller 26 can receive feedback data during vehicle 12 movement regarding measured vehicle speed and localization (by way of speed sensor 56 and positioning system 22, respectively) such that controller 26 can apply brake pressure and reduce engine speed to bring the vehicle 12 to a standstill at the final target position with hitch ball 34 at endpoint 35.

In addition to the general positioning of vehicle 12 relative to trailer 16 and/or coupler 14 for detection and path derivation 66, and any minimum distance requirements, certain additional vehicle-related pre-conditions should be met in order for system 10 to proceed to executing of operating routine 68 for an automated hitching maneuver. Some such pre-conditions may be resolvable by the driver of the vehicle and may include, for example, conditions related to the various states or positions of vehicle features such as: the tailgate 51 must be closed, a hitch ball 34 must be installed with the vehicle 12, no obstructions may be present between the vehicle 12 and the trailer 16, all of the vehicle doors 78 must be closed, the vehicle engine must be running (as determined by the powertrain control system 72), and the vehicle 12 must be fully stopped. System 10, as described herein, is configured to detect when any of such pre-conditions are not met and to notify the driver of vehicle 12 that the related vehicle condition must be corrected to meet the related pre-condition before system 10 will begin an automated hitching maneuver. From this, it can be appreciated that system 10 does not check for such pre-condition before activation of system 10. In a similar manner, system 10 can be configure to wait to check for such user-resolvable pre-conditions until after a trailer 16 and/or coupler 14 has been identified in the image data 55 or can be done simultaneously with the execution of image processing routine 64, as execution of operating routine 68 requires both that all pre-conditions are met, and that a trailer 16 and/or coupler 14 be identified. There may be other steps associated with initiation of system 10, including establishing communication with power steering system 20, brake control system 70, and powertrain control system 72 to ensure that system 10, when needed, can acquire control of such systems. Again, the vehicle pre-condition check described herein can be done after or simultaneously with these and any other initiation steps.

As can be appreciated, any of the above-described pre-conditions that are not met upon an initial system 10 check, can be resolved by the user without disrupting or affecting the state of the above-described system 10 initiation steps or the detection and tracking of a trailer 16 or coupler 14, if present in image data 55. In this respect, the pre-condition check described herein also includes a resolution process that is run as a part of overall operation of system 10, including without having to deactivate or re-activate system 10, once initialized. In this respect, system 10 can provide “coaching”, or guidance for the driver in addressing all of the pre-conditions that are not met upon system 10 activation while system 10 carries out and maintains normal operation up to the point of allowing the user to begin an automated hitching maneuver, which remains prohibited until the needed preconditions are resolved by the driver in accordance with the system 10 coaching. During such coaching, system 10 maintains communication with power steering system 20, brake control system 70, and powertrain control system 72 and continues to locate and/or track an identified trailer 16 or coupler 14 in image data 55 such that, when all preconditions are met, system 10 can resume operation, including by allowing the user to begin an automated hitching maneuver (assuming all other system 10 initiation steps have been completed and the needed trailer 16 or coupler 14 identification has been achieved), without requiring reactivation of system 10.

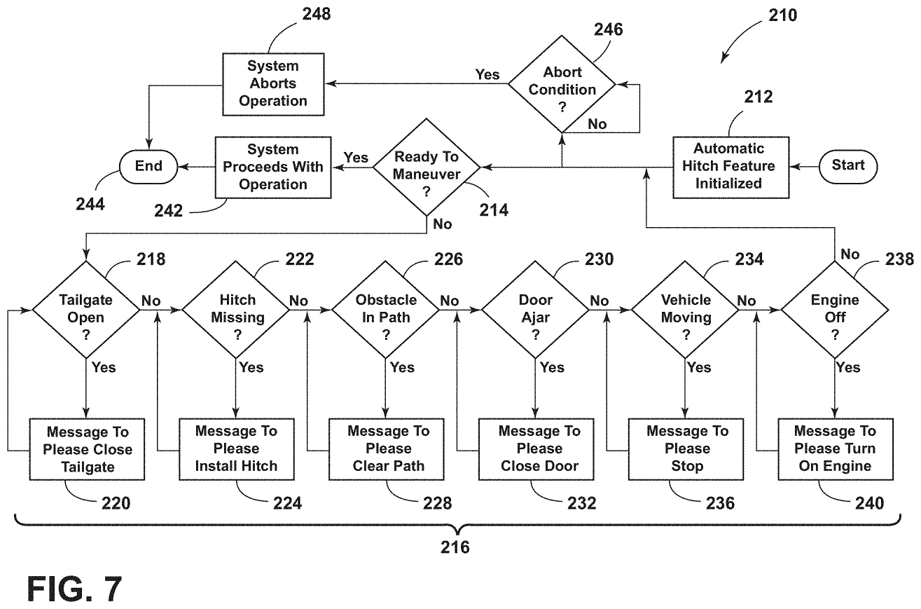

An example of system 10 logic for completing a pre-condition check in an example method 210 according to one aspect of the disclosure is shown in FIG. 7. In the present example, the logic can be stored in memory 62 for use by controller 26 in executing the logic with other system 10 functionality, as described herein. Accordingly, the depicted logic can be implemented as a system status monitoring routine 80. As illustrated, the system 10 is configured to run the system status monitoring routine 80 upon initiation of system 10 alongside the image processing and hitch detection routine 64 and/or the path derivation routine 66, as applicable, but to restrict execution of the operating routine 68 based on an output of the system status monitoring routine 80. In this respect, a determination by system status monitoring routine 80 that all preconditions have not been met can prohibit execution of operating routine 68. Further, system status monitoring routine 80 continues to run during execution of operating routine 68, once permitted, such that a change in any of the precondition states can result in system 10 pausing operating routine 68 (while continuing to track the trailer 16 or coupler 14 and the path 32 using image processing routine 64 and path routine 66).

With continued reference to FIG. 7, the method 210 is discussed in further detail beginning with initiation of system 10 by the driver in step 212. As discussed above system 10 is configured to make an assessment in step 214 of the various vehicle preconditions that are programmed into the system status monitoring routine 80. In step 214, if any of the preconditions are not met, based on an initial output of system status monitoring routine 80, system 10 can enter a coaching process (step 216) to guide the driver through the resolution or correction of any of the preconditions identified as not being met in a predetermined order that can prevent a corrected precondition from being undone by subsequent correction of another precondition.

In the example coaching process 216 of method 210, the system 10 can first check if the vehicle tailgate 18 is open (step 220) by communication with a tailgate latch sensor 53 (FIG. 2) and can present a message 84 on the HMI 40 screen 44 with an instruction 86 indicating that the tailgate 18 must be closed (step 220). Once system 10 determines that the tailgate 18 has been closed (step 218), system 10 checks whether a hitch ball 34 is installed (step 222). This check can be carried out by leveraging image processing routine 64 which can be configured to detect a hitch ball 34 using various image processing algorithms in a similar manner to that which is discussed above with respect to detection of a trailer 16 and/or coupler 14. If no hitch ball 34 is present, system 10 can cause a subsequent message 84 to be displayed on screen 44 (step 224) with an instruction (similar to instruction 86) indicating to the driver that a hitch ball must be installed (alternatively, the same general message 84 can remain with the instruction 86 changing, as needed). Once system 10 determines that a hitch ball 34 is installed with vehicle 12 (step 222), system 10 checks to determine if any objects are present between vehicle 12 and trailer 16 that might obstruct movement of vehicle 12 into alignment with trailer 16 (step 226). System 10 can similarly leverage image processing routine 64 in this step, with the image processing routine 64 being used to identify any objects and determine the positioning thereof relative to vehicle 12. System 10 can then leverage path derivation routine 66 to determine whether any located objects are, for example, within a threshold distance of the planned path 32. In one example, the threshold can correspond with the width of vehicle 12, plus an additional tolerance factor. In another example, the progression of vehicle 12 along path can be charted to determine the full path of vehicle 12 to determine if such expanded path intersects the object. If an obstructing object is present, system 10 can present another subsequent message 84 on screen 44 with an instruction indicating to the driver that the object or vehicle 12 must be moved (step 228).

Once system 10 determines that no potentially obstructing objects are present between vehicle 12 and trailer 16 (step 226), system 10 checks to determine if any of the vehicle doors 78 (FIG. 1) are ajar (step 230) by communication with the various associated door sensors 79 (FIG. 2). If any of the doors 78 are ajar, system 10 can present another subsequent message 84 on screen 44 with an instruction indicating to the driver that the door must be closed (step 232). Once system 10 determines that no doors 78 are ajar (step 230), system 10 checks to make sure that vehicle 12 is not moving (e.g., in a stationary state) (step 234) by communication with vehicle speed sensor 56 (FIG. 2). For this check, system status monitoring routine 80 can use a very low speed threshold as the standstill criteria (i.e. 0±0.02 mph). If it is determined that vehicle 12 is moving, system 10 can present another subsequent message 84 on screen 44 with an instruction indicating to the driver that the vehicle 12 must be brought to a stop (step 236). Once system 10 determines that vehicle 12 has stopped (step 234), system 10 checks to determine if the vehicle engine is in running state ajar (step 238) by communication with the powertrain control system 72 (FIG. 2). If the engine is not running, system 10 can present another subsequent message 84 on screen 44 with an instruction indicating to the driver that the ignition 94 must be turned on (step 240). Once system 10 determines that the vehicle ignition 94 is turned on and the engine is running, system 10 determines that the coaching routine 216 is complete and proceeds with the remaining operational steps, including executing operating routine 68 for an automated hitching maneuver, once the trailer 16 or coupler 14 (as applicable) has been identified and path 32 has been determined (including based on any further tracked movement of trailer 16 or coupler 14 within image data 55 during the completion of coaching routine 216).

As the coaching routine 216 in FIG. 7 is only exemplary, additional criteria may be selected for preconditions to be evaluated in step 214. Such additional criteria may be added to coaching routine 216 in a logical position among the steps discussed above. The determination of the above steps is selected to minimize the potential repetition of coaching steps and to reduce the overall number of coaching steps actually presented. In this respect, an instruction 86 to close the tailgate 18 is given before an instruction to stop the vehicle 12, because the driver will stop the vehicle 12 in order to close the tailgate 18 (which requires exiting of vehicle 12). Similarly, the driver is instructed to close the tailgate 18 before installing a hitch 34 or removing obstacles, because the rear camera 48 on the tailgate 18 is used to detect the hitch ball 34 and/or obstacles using image processing routine 64. The driver is also instructed to install the hitch ball 34 before removing any obstacles, in case the driver is unable to install a hitch ball 34 and, therefore, must end the operation anyway. The driver is instructed to close any vehicle doors 78 only after all checks that may involve the driver (or a passenger) exiting the vehicle 12. The driver is instructed to stop the vehicle 12 after any of the checks that may involve repositioning the vehicle 12 (such that the driver may not yet be interested in solving any other preconditions). The driver is instructed to turn on the engine after all other checks, to prevent unwanted movement of vehicle 12.

It is again noted that, after the above coaching sequence 216 has been completed to resolve any deficient pre-condition checks, system 10 continues to monitor to ensure that pre-conditions remain met, including during execution of operating routine 68. This is due to the fact that the user may have “unset” one of the conditions while solving another later in the order (i.e. the door is opened again after it was closed). In this case, the system returns to the sequence 216. Further, during operation, system 10 also monitors vehicle 12 for any of a number of “abort” conditions (step 248). These conditions are separate from the user-solvable preconditions discussed above such that system 10 responds to the detection of any abort condition by immediately disabling or ending any system 10 processes and deactivating (step 244). Monitoring for such abort conditions (step 248) runs continuously in parallel with the remaining steps. Such abort conditions include: canceling of the operation by the driver using the HMI 40 or vehicle 12 being driven at a speed over a maximum allowed speed. Driving over such a maximum speed (e.g., 10 m.p.h.) can be used to imply that the driver no longer wants to use the functionality provided by system 10 and may be otherwise incompatible (including by various applicable regulations) with using various components of system 10 that are necessary for operation (e.g., rear camera 48). The occurrence of such an abort condition can also prompt system 10 to present an additional message 84 on screen 44 with an indication 86b of system 10 cancellation, as shown in FIG. 9A. An additional abort condition may include an instruction timeout. As can be appreciated based on the above, system 10 operation enters a pause state for execution of the coaching process 216 shown in FIG. 7. The amount of time that the system 10 will stay in such a state may vary by the particular cause of the state. For example, if the system 10 is displaying a message to “please close the tailgate” (step 220), the system 10 will abort if the user does not close the tailgate within a time interval (i.e. 3 minutes). As with other abort conditions, system 10 can present a corresponding message 84 on screen 44, as shown in FIG. 9B. Similar timeout conditions for the various other checks 222,226,230,234,238 can be determined and stored in memory 62.

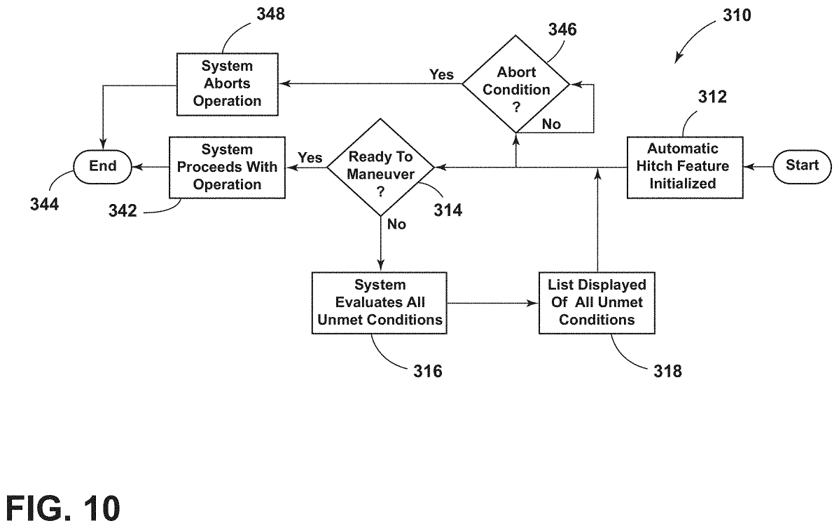

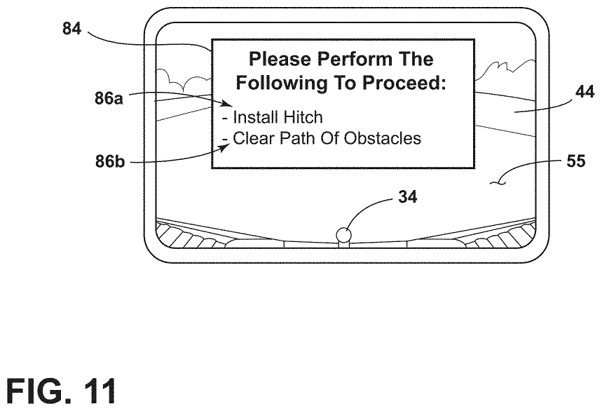

Alternative logic for completing a similar pre-condition check in a further example method 310 according to another aspect of the disclosure is shown in FIG. 10. Similar to the above example, the logic can be stored in memory 62 for use by controller 26 in executing the logic with other system 10 functionality, as described herein. Accordingly, the depicted logic can be implemented as an alternative system status monitoring routine 80 in the system of FIG. 2. As shown in FIG. 10, the method 310 begins, as above, with initiation of system 10 by the driver in step 312. System 10 then makes an assessment in step 314 of the various vehicle preconditions that are programmed into the system status monitoring routine 80 (which can be the same as those discussed above with respect to method 210). In step 314, if any of the preconditions are not met, based on an initial output of system status monitoring routine 80, system 10 enters an alternative coaching process (step 316) to guide the driver through the resolution in a manner and order similar to that which is discussed above. According to the present method 310, however, system 10 is configured to display all unmet conditions as instructions 86a,86b (for example, as shown in FIG. 11) in a single message 84 simultaneously on HMI 40 screen 44, instead of in the individual sequence of FIG. 7. As shown, system 10 only presents instructions for unmet preconditions based on the check in step 314. All such unmet precondition instructions 86a, 86b are displayed in a list in message 84 in an order that is generally the same as the steps 218-240, discussed above such that a similar coaching process is obtained, but with the user having a complete understanding of the number of issues to be addressed. The message 84 can further include an “ok” button to allow the user to indicate that system 10 can recheck the status of the preconditions, or the system may continuously monitor the conditions to automatically determine when all preconditions have been met. Once the coaching process 316 has been completed, system 10 proceeds with operation (step 342) as discussed above, while similarly monitoring 348 for any abort conditions until alignment between hitch ball 34 and coupler 14 has been achieved, at which point the method 310 completes (step 244). The various abort conditions monitored for in step 348 can generally correspond to the examples given above (including a timeout condition) and can similarly result in a premature end to system 10 operation, with a similar message displayed to the driver.

It is to be understood that variations and modifications can be made on the aforementioned system and related structures without departing from the concepts of the present disclosure, and further it is to be understood that such concepts are intended to be covered by the following claims unless these claims by their language expressly state otherwise.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

1. A system for assisting in aligning a vehicle for hitching with a trailer, comprising:
a steering system including a set of vehicle steered wheels;
an imaging system outputting image data; and
a controller:
identifying a coupler of the trailer within the image data;
after identifying the coupler of the trailer within the image data, checking the system for a plurality of pre-maneuver conditions;
while continuing to track the coupler of the trailer within the image data, communicating to a driver the need to correct at least one of the pre-maneuver conditions; and
when all pre-maneuver conditions are met, executing an automated hitching maneuver including controlling the steered wheels of the steering system in backing the vehicle toward the trailer based on the tracked location of the coupler of the trailer within the image data.

2. The system of claim 1, wherein
executing the automated hitching maneuver, including controlling the steering system, is carried out to move the vehicle into an aligned position, where a hitch ball mounted on the vehicle is aligned with the coupler of the trailer.

3. (canceled)

4. The system of claim 1, wherein:
when checking the system for the plurality of pre-maneuver conditions, the controller identifies the at least one of the pre-maneuver conditions to be corrected, communicates the need to correct the at least one pre-maneuver condition to the driver, and after a predetermined timeout interval, aborts the automated hitching maneuver; and
if the controller determines that all of the at least one of the pre-maneuver conditions is corrected prior to the predetermined timeout interval, executes the automated hitching maneuver.

5. The system of claim 1, wherein:
when checking the system for the plurality of pre-maneuver conditions, the controller identifies at least two pre-maneuver conditions to be corrected; and
communicates the need to correct a predetermined first one of one of the at least two pre-maneuver conditions and only communicates a need to correct a predetermined second one of the at least two pre-maneuver conditions after determining that the first one has been corrected.

6. The system of claim 1, wherein when communicating to the driver the need to correct at least one of the pre-maneuver conditions, all of the at least one of the pre-maneuver conditions are simultaneously communicated in a predetermined order.

7. The system of claim 1, wherein the plurality of pre-maneuver conditions includes at least one of the group consisting of: a vehicle tailgate being closed, a vehicle hitch being installed, obstacles between the vehicle and the trailer being moved, a plurality of vehicle doors being closed, the vehicle being stationary, and a vehicle engine being in a running state.

8. The system of claim 1, wherein:
the controller also monitors for a plurality of maneuver abort conditions simultaneously with checking the system for the plurality of pre-maneuver conditions and executing the automated hitching maneuver; and
either disables or ends the automated hitching maneuver upon detecting one of the plurality of maneuver abort conditions, respectively.

9. The system of claim 1, further including a powertrain control system and a brake system, wherein:
executing the automated hitching maneuver further includes controlling the powertrain control system and the brake system to back the vehicle toward the trailer and to stop the vehicle when a hitch of the vehicle is aligned with a coupler of the trailer.

10. A vehicle, comprising:
a steering system including a set of steered wheels; and
a system for assisting in aligning the vehicle for hitching with a trailer, including a controller:
checking the vehicle for a plurality of pre-maneuver conditions;
identifying at least one of the pre-maneuver conditions to be corrected;
communicating to a driver of the vehicle the need to correct the at least one of the pre-maneuver conditions and starting a timer;
if all pre-maneuver conditions are met before the timer indicates expiration of a predetermined timeout period, executing an automated hitching maneuver including controlling the steered wheels of the steering system in backing the vehicle toward the trailer; and
if the timer indicates expiration of the predetermined timeout period before all pre-maneuver conditions are met, canceling the automated hitching maneuver.

11. The vehicle of claim 10, further comprising a vehicle human-machine interface including a screen and in communication with the controller, wherein:
the controller communicates to the driver the need to correct the at least one of the pre-maneuver conditions by causing a message to be presented on the screen.

12. The vehicle of claim 11, wherein:
when checking the vehicle for the plurality of pre-maneuver conditions, the controller identifies at least two pre-maneuver conditions to be corrected; and
communicates the need to correct a predetermined first one of one of the at least two pre-maneuver conditions on the screen and stops communicating the need to correct the first one and only communicates a need to correct a predetermined second one of the at least two pre-maneuver conditions after determining that the first one has been corrected.

13. The vehicle of claim 11, wherein when communicating to the driver the need to correct at least one of the pre-maneuver conditions, all of the at least one of the pre-maneuver conditions are simultaneously communicated in a predetermined order on the screen.

14. The vehicle of claim 10, further including an imaging system outputting image data and in communication with the controller, wherein:
prior to checking the system for the plurality of pre-maneuver conditions, the controller identifies a coupler of the trailer within the image data; and
executing the automated hitching maneuver, including controlling the steering system, is carried out to move the vehicle into a position where a hitch ball mounted on the vehicle is aligned with the coupler of the trailer and includes tracking the position of the coupler relative to the hitch ball in the image data.

15. (canceled)

16. The vehicle of claim 10, wherein the plurality of pre-maneuver conditions includes at least one of the group consisting of: a tailgate of the vehicle being closed, a hitch being installed with the vehicle, obstacles between the vehicle and the trailer being moved, a plurality of doors of the vehicle being closed, the vehicle being stationary, and an engine of the vehicle being in a running state.

17. The vehicle of claim 10, wherein:
the controller also monitors for a plurality of maneuver abort conditions simultaneously with checking the system for the plurality of pre-maneuver conditions and executing the automated hitching maneuver; and
either disables or ends the automated hitching maneuver upon detecting one of the plurality of maneuver abort conditions, respectively.

18. The vehicle of claim 10, further including a powertrain control system and a brake system, wherein:
executing the automated hitching maneuver further includes controlling the powertrain system and the brake system to back the vehicle toward the trailer and to stop the vehicle when a hitch of the vehicle is aligned with a coupler of the trailer.

19. A method for aligning a vehicle for hitching with a trailer, comprising:
identifying a coupler of the trailer within image data received from a vehicle imaging system;
after identifying the coupler of the trailer within the image data, checking the vehicle for a plurality of pre-maneuver conditions;
while continuing to track the coupler of the trailer within the image data, communicating to a driver of the vehicle the need to correct at least one of the pre-maneuver conditions;
when all pre-maneuver conditions are met, executing an automated hitching maneuver including controlling a set of steered wheels of a steering system of the vehicle in backing the vehicle toward the trailer based on the tracked location of the coupler of the trailer within the image data.

20. The method of claim 19, wherein the plurality of pre-maneuver conditions includes at least one of the group consisting of: a vehicle tailgate being closed, a vehicle hitch being installed, obstacles between the vehicle and the trailer being moved, a plurality of vehicle doors being closed, the vehicle being stationary, and a vehicle engine being in a running state.

21. The system of claim 14, wherein the controller continues to track a location of the coupler within the image data when communicating to the driver the need to correct the at least one of the pre-maneuver conditions.

22. The method of claim 19, wherein:
when checking the vehicle for the plurality of pre-maneuver conditions, at least one of the pre-maneuver conditions is identified for correction;
the automated hitching maneuver is only executed if all of the at least one of the pre-maneuver conditions is identified for correction is corrected before expiration of a predetermined timeout period after communicating to the driver the need to correct the at least one of the pre-maneuver conditions; and
if the predetermined timeout period expires before all pre-maneuver conditions are met, the automated hitching maneuver is canceled.
